(19) United States
(12) Patent Application Publication
(10) Pub. No.: US 2021/0198129 A1
(43) Pub. Date: Jul. 1, 2021

(54) METHODS, PRODUCTS & USES RELATING TO SCAVENGING OF ACIDIC SULFIDE SPECIES

(71) Applicant: Innospec Limited, Ellesmere Port, Cheshire (GB)

(72) Inventor: Philip Maltas, Ellesmere Port, Cheshire (GB)

(73) Assignee: Innospec Limited, Ellesmere Port, Cheshire (GB)

(21) Appl. No.: 17/270,330

(22) PCT Filed: Aug. 21, 2019
(86) PCT No.: PCT/GB2019/052360

§ 371 Date: Feb. 22, 2021

(30) Foreign Application Priority Data
Aug. 22, 2018 (GB) 1813645.7

(51) Int. Cl. C02F 1/68; B01D 53/52; C10G 29/20; C10L 3/10

(52) U.S. Cl. CPC C02F 1/683; B01D 53/52; C02F 2101/101; C10L 3/103; C10G 29/20

(57) ABSTRACT

The use of the combination of (a) an amino compound and (b) a compound including a soft electrophilic centre to scavenge and retain acidic sulfide species at a higher temperature and/or scavenge acidic sulfide species at an increased rate compared to that achieved using the amino compound alone.

The present invention relates to methods for improving the scavenging of acidic sulfide species hydrogen sulfide (H₂S). In particular the invention relates to scavenging hydrogen sulfide at a higher temperature and/or an increased rate.

Hydrogen sulfide and other acidic sulfide species are known to be formed within the oil and/or gas reservoir and thus they are an issue throughout the petroleum industry. They are an issue during the exploration, drilling, fracturing, completion, production, storage and transport of crude oil and natural gas. For example, crude oil, natural gas, produced water from within the well, used fracturing fluids, used water-flooding fluids and used drilling muds all may contain hydrogen sulfide.

Hydrogen sulfide and other acidic sulfide species are also problematic during the processing of crude oil and natural gas, where it is liberated by processes such as hydro-processing, cracking and coking. Furthermore, they are known to be present in liquids, distillation residues such as asphalt or bitumen and solids, such as coke, that are present in petroleum refineries. The acidic sulfide species may be present in petroleum refinery liquids such as liquid products, by-products, intermediates and waste streams.

Hydrogen sulfide and other acidic sulfide species are not just problematic for the petroleum industry. These compounds are also known to be present in waste waters, sewage, the effluent from tanneries and paper mills, geothermal fluids and thus geothermal power plants.

Hydrogen sulfide is highly toxic. It is very corrosive and can quickly damage machinery, storage tanks and pipelines. It is also poisonous to many catalysts.

It is therefore desirable to remove hydrogen sulfide and other acidic sulfide species from such materials, or at least reduce the levels present. Various methods of removing hydrogen sulfide and other acidic sulfide species are known. One such method is the use of hydrogen sulfide scavengers, which react selectively with hydrogen sulfide in an attempt to remove it from the material.

The removal of hydrogen sulfide from crude oil or natural gas may occur at various points during the production and processing operations. For example, the hydrogen sulfide may be removed from within the wellbore or during above ground processing, such as during the storage and/or transportation of crude oil or natural gas. The hydrogen sulfide scavengers may also be used during the refining process.

A number of hydrogen sulfide scavengers are currently used in industry. These may be based on organic compounds, bases, metal oxides, metal chelates or oxidising agents. Examples of commonly used organic hydrogen sulfide scavengers include aldehydes and protected aldehydes such as acetals, and nitrogen based scavengers such as amines, triazines and imine compounds. For example US2018/0030360 describes the use of compounds of formula (I):

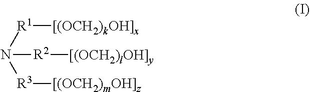

in combination with Michael acceptors as scavengers and antifoulants. One or more of x, y or z may be 0 and one or two of R¹, R² and R³ may be hydrogen.

Metal oxides, metal chelates and oxidising agents are known to react with hydrogen sulfide to form adducts with high thermal stability. However, such adducts are often insoluble solids which may cause blockage during production. Some oxidising scavengers also result in the formation of SOT species, which may cause corrosion and pipeline damage or solid sulfur deposits which can cause blockages.

Some organic hydrogen sulfide scavengers form adducts that are unstable at higher temperatures, often re-releasing hydrogen sulfide gas when heated. Some organic hydrogen sulfide scavengers have slow reaction rates meaning long contact times are needed.

This can be an issue, for example, when scavengers are used in pipelines at low temperatures and the product is later heated, for example in a refinery. This subsequent heating can cause toxic, corrosive sulfide species such as hydrogen sulfide to be re-released.

For example, in scheme 1 monoethanolamine triazine (MEA triazine) forms adduct(s) when reacted with hydrogen sulfide, for example dithanes:

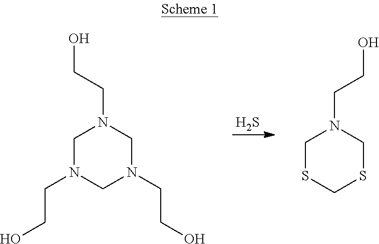

However, heating (for example to temperatures in excess of 100° C.) can lead to the degradation of some or all of the adducts causing hydrogen sulfide gas to be re-released.

There is therefore a need to improve the thermal stability and/or reaction rate of organic hydrogen sulfide scavengers, as well as avoiding the formation of precipitates and corrosive by-products.

According to a first aspect of the present invention there is provided the use of the combination of (a) an amino compound and (b) a compound including a soft electrophilic centre to scavenge and retain acidic sulfide species at a higher temperature and/or scavenge acidic sulfide species at an increased rate compared to that achieved using the amino compound alone.

The present invention relates to the scavenging of an acidic sulfide species.

By acidic sulfide species we mean to refer to any compound including a sulfur atom having a −2 oxidation state bound to an acidic hydrogen atom or the conjugate base thereof. The conjugate base refers to the anion formed on removal of the acidic hydrogen atom.

Suitable acidic sulfide species include H₂S; compounds containing the ions HS⁻ or S²⁻; and any compound or ion containing the functional groups —SH, —S⁻, —S—SH, —S—S⁻, —SₙH, —S₍ₙ₋₁₎S⁻.

Suitable acidic sulfide species include hydrogen sulfide (H₂S) or its anion (HS⁻), sulfide anion (S²⁻); thiols (RSH) and their conjugate base (RS⁻); hydrodisulfides (R—S—S—H) and their conjugate base (R—S—S⁻); or hydropolysulfides (RSₙH) and their conjugate base (RSₙ₋₁S⁻). R may be, for example, an optionally substituted alkyl, alkenyl, aryl, aralkyl, alkaryl or heterocyclic group. However it will be appreciated that the specific nature of the R group is unimportant since it is the sulfur containing functional group that is scavenged.

Preferably the acidic sulfide species is selected from hydrogen sulfide (H₂S), sulfide anion (S²⁻); hydrosulfide ion (HS⁻); compounds including a thiol group (—SH) and their conjugate base (—S⁻).

Preferably the present invention relates to the scavenging of hydrogen sulfide or a source thereof in a sample. By hydrogen sulfide or a source thereof we mean to refer to hydrogen sulfide or a compound which readily generates hydrogen sulfide. Compounds which generate hydrogen sulfide include the thiol, disulfide and polysulfide species mentioned above.

Suitably the present invention relates to the scavenging of hydrogen sulfide.

Thus in especially preferred embodiments the present invention provides the use of the combination of (a) an amino compound and (b) a compound including a soft electrophilic centre to scavenge and retain hydrogen sulfide at a higher temperature and/or scavenge hydrogen sulfide at an increased rate compared to that achieved using the amino compound alone.

The present invention relates to the use of (a) an amino compound in combination with (b) a compound including a soft electrophilic centre.

Component (a) may comprise any amino compound.

Suitable amino compounds for use herein include aliphatic amines and aromatic amines. Suitable amino compounds include monoamines and polyamines.

The amino compound may include one or more primary, secondary or tertiary amine groups.

The amino compound may have the formula RNH₂, R₂NH or R₃N wherein in each case each R group is independently an optionally substituted alkyl, alkenyl, aryl, alkaryl or aralkyl group.

In some embodiments each R group is an unsubstituted alkyl, alkenyl, aryl, alkaryl or aralkyl group.

When R is a substituted alkyl, alkenyl, aryl, alkaryl or aralkyl group, preferred substituents are amino, alkyl amino, alkoxy and hydroxy. R may include a cyclic group.

Suitably each R group is independently an alkyl, alkenyl or aryl having 1 to 20, preferably 1 to 10, suitably 1 to 4 carbon atoms.

In some embodiments two or three R groups may together form a cyclic, bicyclic or tricyclic amine. This may provide aliphatic or aromatic heterocyclic moieties.

Such aliphatic or aromatic heterocycles may further comprise one or more additional heteroatoms, such as sulfur or especially oxygen.

In some embodiments the amino compound may comprise more than one amino functional group.

In some embodiments the amino compound may be a triazine compound, especially an aliphatic triazine compound.

In some embodiments the amino compound may include one or more further non-amino functional groups.

In some embodiments the amino compound may be an oxazolidine compound, especially a bisoxazolidine.

In some embodiments component (a) comprises an amine of formula R¹R²R³N in which each of R¹, R² and R³ is independently selected from hydrogen or an optionally substituted alkyl, alkenyl, aryl, alkaryl or aralkyl group. Suitably at least one of R¹, R² and R³ is not hydrogen.

Each of R¹, R² and R³ may include a cyclic moiety and two or three of the groups R¹, R² and R³ may be joined to form one or more cyclic groups.

In some preferred embodiments R¹ is hydrogen or an optionally substituted alkyl or aralkyl group; R² is hydrogen or an optionally substituted alkyl or aralkyl group; and R³ is an optionally substituted alkyl group or aralkyl group.

For the avoidance of doubt the term aralkyl is used to refer to an aryl substituted alkyl group.

In some preferred embodiments component (a) comprises an amine of formula R¹R²R³N in which each of R¹, R² and R³ is independently selected from hydrogen or an alkyl group which is optionally substituted with a group selected from hydroxy, alkoxy, amino, alkylamino, dialkylamino or aryl, provided that at least one of R¹, R² and R³ is not hydrogen.

In some embodiments none of R¹, R² and R³ is hydrogen and the amino compound is a tertiary amine.

In some embodiments one of R¹, R² and R³ is hydrogen and the amine is a secondary amine.

In some embodiments two of R¹, R² and R³ are hydrogen and the amine is a primary amine.

In some embodiments component (a) may comprise an amine compound of formula (I):

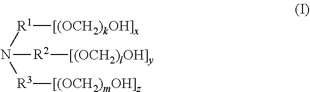

in which R¹, R² and R³ is hydrogen or an optionally substituted alkylenyl, alkenylenyl, alkynylenyl, alkyl, alkenyl or alkaryl group, each of k, l and m is 0 to 25 provided at least one is not 0; x is 0 or 1, y is 0 or 1; z is 0 or 1 and x+y+z is 1, 2 or 3. Compounds of this type are disclosed in US2018/0030360.

Preferably component (a) does not comprise a compound of formula (I).

In some embodiments component (a) comprises an amine of formula R¹R² R³N in which each of R¹, R² and R³ may be an alkyl group which is optionally substituted with a group selected from hydroxy, alkoxy, amino, dialkyl amino or aryl.

Each of R¹, R² and R³ may be an unsubstituted alkyl group. Such groups may be straight chain or branched, or cyclic.

In some embodiments each of R¹, R² and R³ may be a hydroxy substituted alkyl group. Preferably the hydroxy substituent is at a terminal position. Suitable hydroxy substituted alkyl groups (hydroxyalkyl groups) include those of formula HO(CH₂)ₙ wherein n is at least 1. Other groups including branching and more than one terminal hydroxy group are also within the scope of the invention.

In some embodiments each of R¹, R² and R³ may be an alkoxy substituted alkyl group, for example of formula CH₃(CH₂)ₘO(CH₂)ₙ wherein n is at least 1 and m may be 0 or a positive integer. Branched isomers are also within the scope of the invention.

In some embodiments each of R¹, R² and R³ may be an amino substituted alkyl group, for example a group of formula NH₂(CH₂)ₙ wherein n is at least 1.

In some embodiments each of R¹, R² and R³ may be an alkyl amino or dialkyl amino substituted alkyl group, for example a group of R′NH(CH₂)ₙ or R′R″N(CH₂)ₙ wherein n is at least one and R′ and R″ are each alkyl groups.

In some embodiments each of R¹, R² or R³ may be aryl substituted alkyl group for example Ar—(CH₂)ₙ wherein n is at least one and Ar is an aryl group, for example an optionally substituted phenyl group.

In some embodiments each of R¹, R² and R³ may comprise a cyclic moiety. The cyclic moiety may include one or more heteroatoms. Suitable cyclic moieties include cyclohexyl, morpholino and piperazinyl groups.

In some embodiments each of R¹, R² and R³ may include an alkoxylated moiety of formula HO(R′O)ₙR″ in which each of R′ and R″ is an alkylene group and n is at least one. Suitably each of R′ and R″ has 1 to 12, preferably 1 to 6, suitably 1 to 4 carbon atoms. R′ and R″ may be the same or different. When n is greater than 1, each R′ may be the same or different.

Thus in some embodiments component (a) may comprise an alkoxylated amine, for example an ethoxylated and/or propoxylated amine.

In some embodiments component (a) may comprise a polyamine. By polyamine we mean to refer to any compound including two or more amino functional groups. Each of the two or more functional groups may independently be primary, secondary or tertiary amino groups. The polyamine may be a cyclic polyamine. Suitable diamines include piperazine and derivatives thereof, and dimethylaminopropylamine. Other suitable polyamines include polyalkylene polyamines, for example polyethylene polyamines. The skilled person will appreciate that commercial sources of polyalkylene polyamines, for example polyethylene polyamines, will typically comprise a mixture of compounds, for example different homologues and/or different isomers.

Suitably each of groups R¹, R² and R³ has 1 to 12 carbon atoms, for example 1 to 6 carbon atoms.

In some preferred embodiments component (a) comprises an amino compound selected from alkylamines, alkanolamines, alkoxyalkyl amines and mixtures thereof. Amines which include a mixture of alkyl and/or hydroxyalkyl and/or alkoxyalkyl substituents also fall within this class of compounds. In some embodiments the amino compound is of formula R¹R²R³N, wherein each of R¹, R² and R³ is independently selected from hydrogen, an alkyl group, a hydroxyalkyl group or an alkoxyalkyl group, provided that at least of R¹, R² and R³ is hydrogen. Suitably each of R¹, R² and R³ is independently selected from hydrogen and an alkyl, hydroxyalkyl or alkoxyalkyl group having 1 to 20 carbon atoms, preferably 1 to 12 carbon atoms, more preferably 1 to 6 carbon atoms, for example 1 to 4 carbon atoms. Each alkyl, hydroxyalkyl or alkoxyalkyl may be straight chain or branched. In some embodiments R¹, R² and R³ may be a cyclic group. Straight chain groups are preferred. Each of R¹, R² and R³ may be the same or different.

Suitably each of R¹, R² and R³ is independently selected from hydrogen and an alkyl, hydroxyalkyl or alkoxyalkyl group. Each of R¹, R² and R³ may be independently selected from hydrogen, methyl, ethyl, propyl, butyl, pentyl, hexyl, hydroxymethyl, hydroxyethyl, hydroxypropyl, hydroxybutyl, hydroxypentyl, hydroxyhexyl, methoxymethyl, methoxylethyl, methoxypropyl, methoxybutyl, methoxypentyl, methoxyhexyl, ethoxymethyl, ethoxyethyl, ethoxypropyl, ethoxybutyl, ethoxypentyl, ethoxyhexyl, propoxymethyl, propoxyethyl, propoxypropyl, propoxybutyl, propoxypentyl, propoxyhexyl, butoxymethyl, butoxyethyl, butoxypropyl, butoxybutyl, butoxypentyl, butoxyhexyl and isomers thereof. Suitable isomers include, for example cyclohexyl and isopropyl.

In some embodiments the amino compound may be selected from an alkylamine, a hydroxyalkylamine, a dialkylamine, a hydroxyalkyl alkyl amine, a dihydroxyalkylamine, a trialkylamine, a dialkylhydroxyalkylamine, a dihydroxyalkylalkylamine or a trihydroxyalkylamine. There are many different compounds of this type and these will be known to the person skilled in the art. In some embodiments the amine may be a cyclic amine.

Preferred amino compounds of formula R¹R²R³N include monoethanolamine, triethylamine, methoxypropylamine, cyclohexylamine, triethanolamine, 3-phenylpropylamine, diethanolamine, 2-aminopropylamine, tributylamine, N-(2-hydroxyethyl)ethylenediamine, N¹,N¹-bis(2-aminoethyl)-1,2-ethanediamine, 1-(2-aminoethyl)piperazine, 4-(2-aminoethyl)phenol, 2-amino-2-(hydroxymethyl)propane-1,3-diol, 4-(2-aminoethyl)morpholine, 2-(2-aminoethoxy)ethanol, dimethylaminopropylamine, ethylene diamine and 1,8-diazabicyclo(5.4.0)undec-7-ene (DBU).

Especially preferred amino compounds of formula R¹R²R³N include monoethanolamine, methoxypropylamine, triethylamine, 2-aminoethoxyethanol and N-(2-hydroxyethyl) ethylene diamine.

In some embodiments component (a) comprises a triazine. As those skilled in the art will appreciate, in the field of the present invention the term triazine is used to refer to the condensation product of 3 primary amine molecules and 3 aldehyde molecules.

The triazine may be optionally substituted on at least one of the nitrogen atoms.

Suitably the triazine is a compound having an aliphatic core of formula (II):

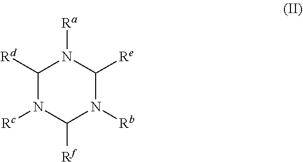

wherein each of R^{a}, R^{b}, R^{c}, R^{d}, R^{e} and R^{f} is independently selected from hydrogen or an optionally substituted hydrocarbyl group.

R^{d}, R^{e} and R^{f} may each be the same or different. Preferably R^{d}, R^{e} and R^{f} are the same.

Preferably each of R^{d}, R^{e} and R^{f} is hydrogen or an optionally substituted alkyl or aryl group.

Preferred alkyl and aryl groups have 1 to 20 carbon atoms, preferably 1 to 10 carbon atoms, more preferably 1 to 4 carbon atoms.

Preferably each of R^{d}, R^{e} and R^{f} is hydrogen or an unsubstituted alkyl group.

Preferably each of R^{d}, R^{e} and R^{f} is hydrogen.

R^{a}, R^{b} and R^{c} may each be the same or different. Preferably R^{a}, R^{b} and R^{c} are the same.

Preferably each of R^{a}, R^{b} and R^{c} is an optionally substituted alkyl, alkenyl, aryl, alkaryl or aralkyl group.

Preferably each of R^{a}, R^{b} and R^{c} has 1 to 20 carbon atoms, preferably 1 to 10 carbon atoms, more preferably 1 to 4 carbon atoms.

Preferably each of R^{a}, R^{b} and R^{c} is an optionally substituted alkyl group.

Preferably each of R^{a}, R^{b} and R^{c} is an unsubstituted alkyl group or a hydroxy-substituted alkyl group.

Preferably each of R^{a}, R^{b} and R^{c} is an alkyl group or a hydroxyalkyl group having 1 to 10, preferably 1 to 6, more preferably 1 to 4 carbon atoms.

Suitably each of R^{a}, R^{b} and R^{c} is hydroxyethyl, methoxypropyl or methyl.

In one preferred embodiment each of R^{a}, R^{b} and R^{c} is hydroxyethyl.

In some preferred embodiments the triazine is monoethanolamine (MEA) triazine.

In some preferred embodiments the triazine is monomethylamine (MMA) triazine.

In some preferred embodiments the triazine is methoxypropylamine (MOPA) triazine.

In some embodiments component (a) comprises an oxazolidine compound. Preferred oxazolidine compounds are bisoxazolidine compounds of formula (III):

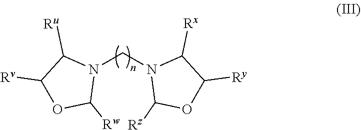

wherein n is at least 1 and each of R^{u}, R^{v}, R^{w}, R^{x}, R^{y} and R^{z} is independently hydrogen or an optionally substituted alkyl, alkenyl, aryl, alkaryl or aralkyl group.

Preferably each of R^{u}, R^{v}, R^{w}, R^{x}, R^{y} and R^{z} is hydrogen or an optionally substituted alkyl group.

Preferably each of R^{u}, R^{v}, R^{w}, R^{x}, R^{y} and R^{z} is hydrogen or an unsubstituted alkyl group, suitably having 1 to 12 carbon atoms.

Preferably each of R^{u}, R^{w}, R^{x} and R^{z} is hydrogen and RV and RY is each a C₁ to C₄ alkyl group.

Preferably RV is methyl and RY is methyl.

n is suitably 1 to 6, preferably 1 to 4. Most preferably n is 1.

One especially preferred compound of formula (III) for use herein is methylene bis(5-methyloxazolidine).

Component (a) may comprise a mixture of two or more amino compounds.

Preferably component (a) comprises an amino compound selected from triazines, oxazolidines, polyamines and amines of formula R¹R²R³N in which each of R¹, R² and R³ is independently selected from hydrogen or an optionally substituted hydrocarbyl group.

Preferably component (a) comprises an amino compound selected from triazines, bisoxazolidines, alkylamines, alkanolamines, alkoxyalkyl amines and mixtures thereof.

Suitably component (a) comprises amino compound selected from triazines, oxazolidines, polyamines and amines of formula R¹R²R³N in which each of R¹, R² and R³ is independently selected from hydrogen, alkyl or hydroxyalkyl.

Suitably component (a) comprises one or more amino compounds selected from:
a triazine of formula (II):

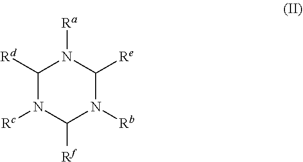

in which each of R^{a}, R^{b}, R^{c}, R^{d}, R^{e} and R^{f} is hydrogen or an optionally substituted hydrocarbyl group;
a bisoxazolidine of formula (III):

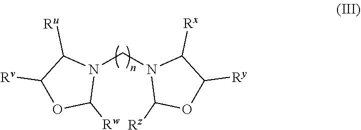

wherein n is at least 1 and each of R^{u}, R^{v}, R^{w}, R^{x}, R^{y} and R^{z} is independently hydrogen or an optionally substituted alkyl, alkenyl, aryl, alkaryl or aralkyl group; and

an amine of formula R¹R²R³N in which each of R¹, R² and R³ is independently hydrogen or an optionally substituted alkyl, alkenyl, aryl, alkaryl or aralkyl group, provided that at least one of R¹, R² and R³ is not hydrogen.

Preferably component (a) comprises one or more amino compounds selected from:
a triazine of formula (IIA):

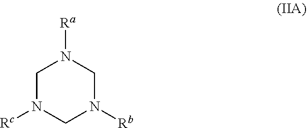

in which each of R^{a}, R^{b} and R^{c} is an alkyl, hydroxyalkyl or alkoxyalkyl group;
methylene bis(5-methyloxazolidine); and
an amine of formula R¹R²R³N in which each of R¹, R² and R³ is independently hydrogen or an alkyl group which is optionally substituted with a group selected from hydroxy, alkoxy, amino, alkylamino, dialkylamino or aryl, provided that at least one of R¹, R² and R³ is not hydrogen.

Preferably component (a) comprises one or more amino compounds selected from:
a triazine of formula (IIA):

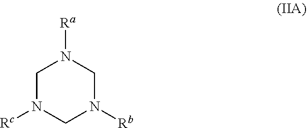

in which each of R^{a}, R^{b} and R^{c} is an alkyl or hydroxyalkyl group having 1 to 10, preferably 1 to 4 carbon atoms;
methylene bis(5-methyloxazolidine); and
an amine of formula R¹R²R³N in which each of R¹, R² and R³ is hydrogen or an alkyl, hydroxyalkyl or alkoxyalkyl having 1 to 10, preferably 1 to 4 carbon atoms, provided that at least one of R¹, R² and R³ is not hydrogen.

Preferably component (a) comprises one or more amino compounds selected from monoethanolamine triazine (MEA triazine), monomethylamine triazine (MMA triazine), methoxypropylamine triazine (MOPA triazine), methylene bis(5-methyloxazolidine) monoethanolamine, triethylamine, methoxypropylamine, cyclohexylamine, triethanolamine, 3-phenylpropylamine, diethanolamine, 2-aminopropylamine, tributylamine, N-(2-hydroxyethyl)ethylenediamine, N¹,N¹-bis(2-aminoethyl)-1,2-ethanediamine, 1-(2-aminoethyl)piperazine, 4-(2-aminoethyl)phenol, 2-amino-2-(hydroxymethyl)propane-1,3-diol, 4-(2-aminoethyl)morpholine, 2-(2-aminoethoxy)ethanol, dimethylaminopropylamine, ethylene diamine and 1,8-diazabicyclo(5.4.0)undec-7-ene (DBU).

Most preferably component (a) comprises an amino compound selected from one or more of MEA triazine, MMA triazine, MOPA triazine, monoethanolamine, methoxypropylamine, triethylamine, 2-aminoethoxyethanol and N-(2-hydroxyethyl) ethylene diamine.

MEA triazine is especially preferred.

Component (a) is used in combination with component (b), a compound including a soft electrophilic centre.

By electrophilic centre we mean to refer to an electron deficient atom that can be attacked by a nucleophile.

The electrophilic centre may be defined as hard or soft according to the Pearson hard and soft acids and bases (HSAB) theory.

By soft electrophilic centre we mean to refer to an electron deficient atom characterised by a high polarizability, low electronegativity and low charge density.

The compound including a soft electrophilic centre is preferably an organic compound.

Suitably the soft electrophilic centre is an electron deficient carbon atom.

In some embodiments the electron deficient carbon atom is bonded to a halide, for example Cl, Br and I.

In some embodiments the electron deficient carbon atom may be bonded to a halogen atom selected from Br and I.

Preferably the electron deficient carbon atom is bonded to Br. For example component (b) may comprise a compound of formula (IV):

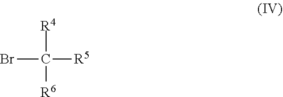

wherein R⁴, R⁵ and R⁶ may each independently be selected from hydrogen, an oxygenated functional group or an optionally substituted hydrocarbyl group. Preferably at least one of R⁴, R⁵ and R⁶ is hydrogen. Preferably two of R⁴, R⁵ and R⁶ is hydrogen.

Suitable oxygenated functional groups are carboxylic acids, esters, amides, imides, imines, aldehydes, ketones and other carbonyl or imine derived functional groups.

One especially preferred compound having a soft electrophilic centre of formula (IV) is 2-bromoethanoic acid, wherein R⁴ is COOH and R⁵ and R⁶ are H.

In some embodiments the electron deficient carbon atom of the soft electrophilic centre is bonded to a chlorine atom. Although simple alkyl halides are generally not regarded as soft electrophiles, compounds in which a carbon atom bonded to a chlorine atom is adjacent to a further stabilising functional groups may be regarded as a soft electrophilic centre within the definition of component (b) of the present invention.

In some embodiments the compound having a soft electrophilic centre may comprise a halogen substituent adjacent to a carbonyl group.

For example component (b) may comprise a compound of formula (VII):

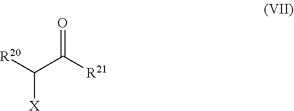

wherein X is Cl, Br or I, R²⁰ is selected from hydrogen, an optionally substituted hydrocarbyl group, COR²² or COOR²³; and R²¹ is hydrogen, an optionally substituted hydrocarbyl group, OR²⁴ or NR²⁵R²⁵ wherein each of R²², R²³, R²⁴, R²⁵ and R²⁶ may be hydrogen or an optionally substituted hydrocarbyl group.

Preferably X is Cl or Br.

Preferably R²¹ is an optionally substituted alkyl group or a group of formula OR²⁴ wherein R²⁴ is an optionally substituted alkyl group.

Preferably R²¹ is an optionally unsubstituted alkyl group or OR²⁴ wherein R²⁴ is an unsubstituted alkyl group.

R²⁰ is preferably hydrogen, COR²² or COOR²³ wherein R²² or R²³ is an optionally substituted alkyl group, preferably an unsubstituted alkyl group.

Preferred compounds of formula (VII) include 3-chloro-2-butanone, 3-chloro 2,4 pentanedione, diethyl bromomalonate, ethyl bromoacetate, chloroacetic acid and ethyl-2-chloroacetoacetate.

An especially preferred compound of formula (VII) is ethyl-2-chloroacetoacetate.

Suitably the compound including a soft electrophilic centre may be an α,β-unsaturated ketone, an ester, a carboxylic acid, an amide, an anhydride, an aldehyde or an imide.

In some embodiments the compound including a soft electrophilic centre may be an aldehyde. Preferably any such compound does not include two adjacent aldehyde functional groups. For the avoidance of doubt glyoxal is not considered to be a compound including a soft electrophilic centre within the meaning of the present invention. In preferred embodiments component (b) does not comprise glyoxal.

Preferred aldehydes for use in component (b) are aliphatic aldehydes.

In some preferred embodiments the compound including a soft electrophilic centre is an α, β-unsaturated carbonyl compound of formula (V) or (VI):

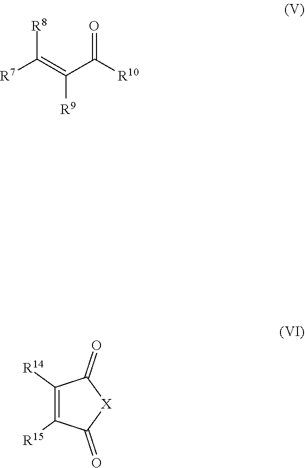

wherein each of R⁷, R⁸ and R⁹ is independently selected from hydrogen and an optionally substituted hydrocarbyl group; R¹⁰ is selected from hydrogen, OH, an optionally substituted hydrocarbyl group, OR¹¹ and NR¹²R¹³; each of R¹⁴ and R¹⁵ is selected from hydrogen and optionally substituted hydrocarbyl group; and X is O or NR¹⁶; wherein R¹¹ is an optionally substituted hydrocarbyl group; each of R¹² and R¹³ is hydrogen or an optionally substituted hydrocarbyl group; and R¹⁶ is hydrogen, an optionally substituted hydrocarbyl group, OH, NH₂, COOH or CONH₂.

In some embodiments R¹⁶ is hydrogen or an optionally substituted hydrocarbyl group.

Preferably each of R⁷, R⁸ and R⁹ is hydrogen or an optionally substituted alkyl group.

Preferably each of R⁷, R⁸ and R⁹ is hydrogen or an unsubstituted alkyl group.

Preferably each R⁷, R⁸ and R⁹ is hydrogen or an unsubstituted alkyl group having 1 to 20 carbon atoms, preferably 1 to 10 carbon atoms, suitably 1 to 4 carbon atoms.

Preferably R⁹ is hydrogen.

Preferably at least one of R⁷ and R⁸ is hydrogen.

Preferably R⁷, R⁸ and R⁹ are all hydrogen.

R¹⁰ is preferably OR¹¹, H or an optionally substituted alkyl group.

When R¹⁰ is an optionally substituted alkyl group, it preferably has 1 to 10, more preferably 1 to 4 carbon atoms. When R¹⁰ is an alkyl group it is preferably an unsubstituted alkyl group.

When R¹⁰ is OR¹¹, R¹¹ is preferably an optionally substituted alkyl group. Preferably R¹¹ is an unsubstituted alkyl group. Preferably R¹¹ has 1 to 10 carbon atoms, more preferably 1 to 4 carbon atoms.

Most preferably R¹⁰ is hydrogen.

In preferred embodiments the compound of formula (V) is an α,β-unsaturated aldehyde, such that R¹⁰ is hydrogen and R⁷, R⁸ and R⁹ may be independently selected from hydrogen or a hydrocarbyl group.

Suitable aldehydes of this type include propenal, crotonaldehyde and methacrolein.

In especially preferred embodiments the compound of formula (V) is propenal and R⁷, R⁸, R⁹ and R¹⁰ are all hydrogen. Propenal is also known as acrolein.

Preferably each of R¹⁴ and R¹⁵ is hydrogen or an optionally substituted alkyl group. Preferably each of R¹⁴ and R¹⁵ is hydrogen or an unsubstituted alkyl group having 1 to 20 carbon atoms, preferably 1 to 10 carbon atoms, suitably 1 to 4 carbon atoms.

In some preferred embodiments each of R¹⁴ and R¹⁵ is hydrogen.

In one preferred embodiment X is 0, R¹⁴ and R¹⁵ are both hydrogen and the compound of (VI) comprises maleic anhydride.

Preferably X is NR¹⁶. R¹⁶ may be hydrogen or an optionally substituted hydrocarbyl group. Such compounds may be referred to herein as optionally substituted maleimides.

In some embodiments R¹⁶ is a substituted hydrocarbyl group. In some embodiments R¹⁴ and R¹⁵ are both hydrogen, X is NR¹⁶ and R¹⁶ is selected from hydrogen, CH₂OH, CH₂CH₂OH, CONH₂, CH₂COOH and OH.

In some embodiments R¹⁶ is CONH₂. This compound is known as 2,5-dioxo-2,5-dihydro-1H-pyrrole-1-carboxamide.

Other suitable maleimide-derived compounds which may be provided in component (b) include the compound of formula (VIII) and the compound of formula (IX):

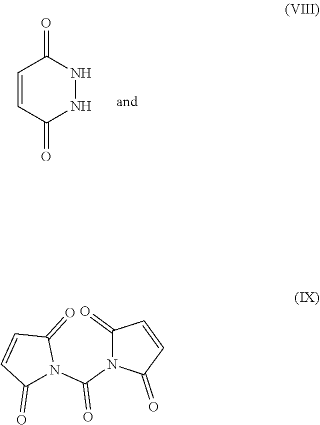 [SMILES: O=c1ccc(=O)[nH][nH]1 ; O=C1C=CC(=O)N1C(=O)N1C(=O)C=CC1=O]

Preferably R¹⁶ is hydrogen or an optionally substituted alkyl group. Preferably R¹⁶ is hydrogen or an unsubstituted alkyl group having 1 to 20 carbon atoms, preferably 1 to 10 carbon atoms, suitably 1 to 4 carbon atoms. Most preferably R¹⁴, R¹⁵ and R¹⁶ is hydrogen, and the compound of formula (VI) is maleimide.

Preferably component (b) comprises a compound including a soft electrophilic centre selected from α,β-unsaturated aldehydes, optionally substituted maleimides, maleic anhydride and halogenated compounds including an electron deficient carbon atom.

Most preferably component (b) comprises a compound including a soft electrophilic centre selected from α,β-unsaturated aldehydes and optionally substituted maleimides.

In some embodiments component (b) is selected from propenal, maleimide, ethyl-2-chloroacetoacetate, maleic anhydride and mixtures thereof.

Preferably component (b) comprises propenal and/or maleimide.

In preferred embodiments the present invention involves the combination of (a) an amino compound selected from triazines, methylene bis(5-methyloxazolidine), alkylamines, alkanolamines and alkoxyalkylamines; and (b) a compound including a soft electrophilic centre selected from α,β-unsaturated aldehydes and maleimides.

According to a second aspect of the present invention there is provided a method of scavenging acid sulfide species from an industrial or environmental material, the method comprising contacting the material with:
(a) an amino compound selected from triazines, oxazolidines, polyamines and amines of formula R¹R²R³N in which each of R¹, R² and R³ is independently hydrogen or an alkyl group which is optionally substituted with a group selected from hydroxy, alkoxy, amino, alkylamino, dialkylamino or aryl, provided that at least one of R¹, R² and R³ is not hydrogen; and
(b) a compound including a soft electrophilic centre.

According to a third aspect of the present invention there is provided a product for scavenging acid sulfide species, the product comprising:
(a) an amino compound selected from triazines, oxazolidines, polyamines and amines of formula R¹R²R³N in which each of R¹, R² and R³ is independently hydrogen or an alkyl group which is optionally substituted with a group selected from hydroxy, alkoxy, amino, alkylamino, dialkylamino or aryl, provided that at least one of R¹, R² and R³ is not hydrogen; and
(b) a composition comprising a compound including a soft electrophilic centre.

According to the first aspect of the present invention the combination of (a) the amino compound and (b) the compound including a soft electrophilic centre scavenges and retains acidic sulfic species, for example hydrogen sulfide at a higher temperature and/or an increased rate compared to when the amino compound alone is used.

By scavenging acidic sulfide species we mean to refer to the removal or reduction of the amount of acidic sulfide species present in a material.

By retains acidic sulfide species we mean that the acid sulfide species are not readily re-released.

Suitably the first aspect relates to the use of the combination of (a) the amino compound and (b) the compound including a soft electrophilic centre to scavenge and retain acidic sulfide species, for example hydrogen sulfide, from an industrial or environmental material.

One problem of the prior art is that some hydrogen sulfide scavengers re-release hydrogen sulfide at high temperatures, for example at temperatures greater than 100° C.

The claimed combination of component (a) and component (b) may scavenge and retain acidic sulfide species, for example hydrogen sulfide at higher temperatures relative to the temperature at which the amino compound scavenges and retains the acidic sulfide species when it is used alone.

Suitably the combination of the amino compound (a) and the compound including the soft electrophilic centre (b) scavenges and retains acid sulfide species for example hydrogen sulfide at temperatures of at least 140° C. Preferably the combination scavenges and retains acidic sulfate species, for example hydrogen sulfide at temperatures of at least 150° C. In some embodiments, for example when component for example when component (a) comprises propenal and/or maleimide the combination scavenges and retains acidic sulfate species, for example hydrogen sulfide, at temperatures of at least 160° C. or 170° C. In some especially preferred embodiments the amino compound scavenges and retains acidic sulfide species, for example hydrogen sulfide at temperatures of at least 180° C.

Thus the present invention suitably provides the use of (a) an amino compound in combination with (b) a compound including a soft electrophilic centre to scavenge and retain acidic sulfide species at temperatures of at least 140° C., for example of at least 180° C. Suitably the acidic sulfide species is retained at temperatures of at least 140° C., for example of at least 180° C. for at least 10 minutes. The acidic sulfide species (for example hydrogen sulfide) may be retained at temperatures of at least 140° C. for at least 20 minutes or at least 30 minutes.

The use of (a) an amino compound in combination with (b) a compound including a soft electrophilic centre may increase the rate at which acid sulfide species are scavenged.

By the rate at which an acidic sulfide compound is scavenged and retained we mean to refer to the change in concentration of the acidic sulfide species over time. The increase in rate is relative to the rate at which the amino compound scavenges an acidic sulfide species when used alone.

Suitably the use of the combination of (a) an amino compound and (b) a compound including a soft electrophilic centre scavenges and retains the acid sulfide species present in an industrial or environmental material at an increased rate under identical conditions of temperature and concentration than would be achieved using the amino compound alone. Suitably the time period to reduce the acidic sulfide species concentration by the same amount at the same temperature using the combination is less than half the time period when using the amino compound alone.

A further advantage of some embodiments of the present invention is that the combination of (a) an amino compound and (b) a compound including a soft electrophilic centre may reduce the formation of precipitates compared with the use of the amino compound alone.

For some amines, especially when used at low concentrations, precipitates can occur following contact with an industrial or environmental material to scavenge acidic sulfide species.

It has advantageously been found that the formation of precipitates is reduced when using a combination of (a) an amino compound and (b) a compound including a soft electrophilic centre according to the present invention.

Thus the present invention may further provide the use of the combination of (a) an amino compound and (b) a compound including a soft electrophilic centre to scavenge acidic sulfide species wherein the formation of precipitates in the resultant composition is reduced compared to an equivalent system in which only an amino compound is used.

Ethyl-2-chloroacetoacetate has been found to be particularly effective at reducing precipitate formation.

The second aspect of the invention relates to a method of scavenging acid sulfide species from an industrial or environmental material.

The industrial or environmental material may include solids, liquids or gasses that are obtained from any industries or environments where hydrogen sulfide may be present.

The industrial material may be a product, by-product, intermediate or waste stream obtained from an industry and may be solid or a fluid, such as liquid or a gas. For example, the industrial material may be sourced from an oil well, a petroleum refinery, the cargo hold of a vehicle transporting crude oil or petroleum products, an oil pipeline, a farm slurry pit, sewage works, paper mill or tannery.

The industrial or environmental material may be selected from fluids in or extracted from an oil well; products, by-products, intermediates and waste streams from refineries and other industries; water; sewage; and geothermal fluids.

Fluids in or extracted from an oil well may be selected from: crude oil; gas condensate; gas; sour gas; produced water; drilling fluids; fracturing fluids and water flooding fluids.

The drilling fluids and fracturing fluids may preferably be selected from drilling fluids in use, used drilling fluids, fracturing fluids in use and used fracturing fluids.

The products, by-products, intermediates and waste streams from refineries and other industries may be solids or fluids such as liquids or gases.

Other industries may be selected from biofuel production, farming, tanneries, paper mills and power.

In one embodiment, the industrial or environmental material may be selected from: gas condensate; gas; drilling fluids in use; used drilling fluids; fracturing fluids in use; used fracturing fluids; solid products, by-products, intermediates and waste streams from refineries; fluid products, by-products, intermediates and waste streams from refineries; and solid and liquid products, by-products, intermediates and waste streams from other industries such as biofuel production, farming, tanneries, paper mills and power.

In a preferred embodiment, the industrial or environmental material is selected from crude oil, produced water, petroleum refinery liquids, coke, asphalt or bitumen, used fracturing fluids, used water-flooding fluids, brines, geothermal fluids or sour gas.

The present invention may be useful for scavenging acidic sulfide species, for example hydrogen sulfide, from crude oil.

In one preferred embodiment the industrial or environmental material comprises crude oil.

One particular advantage of the present invention is that it can be used to scavenge and retain acidic sulfide species, for example hydrogen sulfide, from water containing materials and aqueous based systems, for example brines.

In one embodiment the industrial or environmental material suitably comprises water. In some embodiments it may comprise at least 30 wt % water, for example at least 50 wt % water, at least 70 wt % water or at least 90 wt % water.

Brines and other aqueous media are commonly used or produced in crude oil recovery and treatment processes and in other industrial applications.

The present invention may provide the use of the combination of (a) an amino compound and (b) a compound including a soft electrophilic centre to scavenge and retain acidic sulfide species, for example hydrogen sulfide, from an aqueous based industrial or environmental fluid at a higher temperature and/or a increased rate compared to using the amino compound alone.

Typically the industrial or environmental material may comprise up to 1000 mg of hydrogen sulfide per litre (L) of material. In some embodiments, the industrial or environmental material contains up to 500 mg/L, or for example up to 200 mg/L of hydrogen sulfide. It may contain up to 150 mg/L or 100 mg/L of hydrogen sulfide. For example, the industrial or environmental material may contain 0.01 to 100 mg/L or 0.1 to 100 mg/L of hydrogen sulfide.

In the method of the second aspect (a) the amino compound and (b) the compound including a soft electrophilic centre may be added to the material in a single composition or they may be provided in separate compositions. Preferably they are provided in separate compositions.

When component (a), the amino compound, and component (b), the compound including a soft electrophilic centre, are contacted with each other they suitably form one or more reaction products. Depending on the conditions at which they are contacted, the reaction product(s) may either be in the form of a liquid or a solid.

Thus in embodiments in which component (a) and component (b) are added to the industrial or environmental material in a single composition the conditions are suitably selected to prevent or reduce the formation of solid reaction product(s). Preferably in such embodiments the amino compound (a) and the compound including a soft electrophilic centre (b) are mixed at 0° C. to form the single composition. When a single composition is used, it is preferably rapidly contacted with the industrial or environmental fluid as the performance may decrease with time.

Preferably component (a) and component (b) are provided in separate compositions.

Suitably the amounts of (a) the amino compound and (b) the compound including a soft electrophilic centre added to the industrial or environmental material is dependent on various factors, for example the amount of acidic sulfide species, for example hydrogen sulfide, present in the material; the desired final level of acidic sulfide species in the material; the exact natures of the amino compound and the compound including a soft electrophilic centre; the reaction time needed to achieve the desired level of acidic sulfide species and the temperature of the environmental or industrial material.

The selection of appropriate conditions will be within the competence of the person skilled in the art.

Suitably the composition comprising an amino compound may be contacted with the industrial or environmental material before the composition comprising a compound including a soft electrophilic centre is contacted with the industrial or environmental material. Alternatively the composition comprising an amino compound may be contacted with the industrial or environmental material after the composition comprising a compound including a soft electrophilic centre is contacted with the industrial or environmental material.

Preferably the industrial or environmental material is contacted concurrently with a composition comprising an amino compound and a composition comprising a compound including a soft electrophilic centre.

The method of the second aspect preferably involves adding a first composition comprising preferably the amino compound and a second separate composition comprising the compound including a soft electrophilic centre. Suitably the first and second compositions are added separately and concurrently to the industrial or environmental material.

Suitably the amount of (a) the amino compound and (b) the compound including a soft electrophilic centre used in the method of the second aspect is determined based on the estimated concentration of acidic sulfide species present in the industrial or environmental material.

In preferred embodiments from 0.1 to 20 molar equivalents of (a) the amino compound is added to industrial or environmental material per mole of acidic sulfide species, preferably from 0.5 to 10 molar equivalents.

In preferred embodiments from 0.1 to 20 molar equivalent of (b) the compound including a soft electrophilic centre is added to industrial or environmental material per molar of acidic sulfide species, preferably from 0.5 to 10 molar equivalents.

Suitably the molar ratio of (a) the amino compound to (b) the compound including a soft electrophilic centre is from 10:1 to 1:100, preferably from 5:1 to 1:50, for example from 2:1 to 1:10.

In some embodiments the composition comprising the amino compound and the composition comprising the compound with a soft electrophilic centre are admixed with the industrial or environmental material in an amount of from 0.1 ppm to 10000 ppm, preferably in an amount of from 10 ppm to 1000 ppm.

In some embodiments the amino compound is provided in an aqueous composition and/or the compound including a soft electrophilic centre is provided in an aqueous composition.

The method of the second aspect may suitably be carried out using a product of the third aspect.

The product of the third aspect suitably comprises:
(a) a first composition comprising an amino compound selected from selected from triazines, bisoxazolidines, alkylamines, alkanolamines, alkoxyalkyl amines and mixtures thereof; and
(b) a second composition comprising a compound including a soft electrophilic centre.

The product of the third aspect preferably comprises:
(c) a first composition comprising an amino compound selected from triazines and amines of formula R¹R²R³N in which each of R¹, R² and R³ is independently selected from hydrogen or an alkyl group which is optionally substituted with a group selected from hydroxy, alkoxy, amino, alkylamino, dialkylamino or aryl, provided that at least one of R¹, R² and R³ is not hydrogen; and
(d) a second composition comprising a compound including a soft electrophilic centre.

The first composition comprising the amino compound may comprise a mixture of two or more amino compounds. In some embodiments the composition further comprises a solvent.

Suitable solvents include organic solvents and aqueous solvents.

The first composition may comprise a mixture of two or more solvents.

Suitable organic solvents include aromatic and aliphatic solvents, including oxygenated solvents and halogenated solvents.

In some embodiments water is the major solvent present in the composition. In some embodiments water provides for at least 50 wt % of all solvents present in the composition, preferably at least 60 wt %, more preferably at least 70 wt %, suitably at least 80 wt %, for example at least 90 wt % or at least 95 wt %. In some embodiments one or more further water miscible solvents may be present. Examples of suitable water miscible solvents include monohydric and polyhydric alcohols, for example ethanol, glycerol, isopropanol, methanol, diethylene glycol, propylene glycol and polyethylene glycol.

In some embodiments, for example when component (a) comprises maleimide, maleic anhydride or ethyl-2-chloroacetoacetate, an organic solvent may be the major solvent present in the first composition. Suitable organic solvents include methyl ethyl ketone, acetone, toluene, ethyl acetate, xylene, dimethylformaldehyde, methyl isobutyl ketone, mixed aromatic solvents (such as those sold under the trade mark Caromax) and mixtures thereof.

Suitably the amino compound is present in the first composition in an amount of from 1 to 100 wt %, preferably 5 to 100 wt %, for example 10 to 100 wt %.

The second composition comprising the compound including a soft electrophilic centre may comprise a mixture of two or more such compounds.

In some embodiments the composition further comprises a solvent. Suitable solvents include organic solvents and aqueous solvents.

The second composition may comprise a mixture of two or more solvents.

Suitable organic solvents include aromatic and aliphatic solvents, including oxygenated solvents and halogenated solvents.

Suitably water is the major solvent present in the composition. In some embodiments water provides for at least 50 wt % of all solvents present in the composition, preferably at least 60 wt %, more preferably at least 70 wt %, suitably at least 80 wt %, for example at least 90 wt % or at least 95 wt %. In some embodiments one or more further water miscible solvents may be present. Examples of suitable water miscible solvents include monohydric and polyhydric alcohols, for example ethanol, glycerol, isopropanol, methanol, diethylene glycol, propylene glycol and polyethylene glycol.

Suitably the compound including a soft electrophilic centre is present in the second composition in an amount of from 1 to 100 wt %, preferably 5 to 100 wt %, for example 10 to 100 wt %.

The first and second compositions of the product of the third aspect of the present invention may each further comprise one or more further components. In some embodiments a scale inhibitor may be present in the first composition and/or in the second composition. Suitable scale inhibitors are known to those skilled in the art.

In some embodiments a corrosion inhibitor may be present in the first composition and/or in the second composition. Suitable corrosion inhibitors are known to those skilled in the art.

The first and second compositions may each further comprise one or more further components selected from biocides, friction reducers, drag reducing agents, surfactants, foaming agents, carbon dioxide scavengers, oxygen scavengers and metal scavengers.

The use of the first aspect and the method of the second aspect are suitably carried out using a first composition comprising an amino compound and a second composition comprising a compound including a soft electrophilic centre. These compositions are suitably as defined in relation to the third aspect.

In some embodiments the product of the third aspect may further comprise (c) a scale inhibitor and/or a corrosion inhibitor.

In some embodiments the product of the third aspect may comprise means for delivering the first composition comprising (a) the amino compound and/or means for delivering the composition comprising (b) the compound including a soft electrophilic centre into the industrial or environmental material. Suitable means will be known to the person skilled in the art and include, for example injection means.

The first and/or second compositions may be injected via injection quills. In some preferred embodiments a continuous injection pump with a higher number of strokes per minute can be used. Suitable means of monitoring the quantity and/or injection rate of the compositions would also be used.

The invention will now be further described with reference to the following non-limiting examples.

### EXAMPLE 1

The thermal stability of various combinations of amino compound (a) and a compound including a soft electrophilic centre (b) as hydrogen sulfide scavengers was tested according to the following procedure:

2 ml of a stock solution containing 0.6 mg/ml of Na₂S in water was added to water (8 ml) in a reaction vessel with stirrer bar. The vessel was tightly sealed and hydrogen sulfide was generated in situ by injecting HCl (0.07 ml of 0.5M solution, 2 molar equivalents relative to Na₂S). Thus the solution contained approximately 50 mg/I of hydrogen sulfide. 5 molar equivalents relative to Na₂S of an amino compound (a) and 5 molar equivalents relative to Na₂S of a compound including a soft electrophilic centre (b) were then injected and the mixture heated to 75° C. for 30 minutes with stirring. After cooling to room temperature the scavenged mixture was poured into a transparent pressure vessel. An H₂S indicator was placed inside the pressure vessel (not touching the liquid) and the system sealed. The pressure vessel was then heated (5° C. per minute) to a maximum temperature of 180° C. or until the indicator showed the presence of H₂S in the gas phase. Results are shown in Table 1.

Examples 3 to 17 are of the invention. Examples 1, 2 and 18 are comparative examples.

TABLE 1

| | | Compound including | | Temperature at |
|---|---|---|---|---|
| Ex- | Amino | a soft electrophilic | | which H₂S is re- |
| ample | Compound (a) | centre (b) | Solvent | released |
| 1 | MEA triazine | None | Water | 100° C. |
| 2 | None | Propenal | Water | Does not fully |
| | | | | scavenge after |
| | | | | 30 minutes |
| 3 | MEA triazine | Propenal | Water | >180° C. |
| 4 | MEA triazine | Maleimide | Water | 170° C. |
| 5 | MEA triazine | Crotonaldehyde | Water | 165° C. |
| 6 | MEA triazine | Methacrolein | Water | 150° C. |
| 7 | MEA triazine | Cyclohexanone | Water | 165° C. |
| 8 | Mono- | None | Water | Does not fully |
| | ethanolamine | | | scavenge after |
| | | | | 30 minutes |
| 9 | Mono- | Propenal | Water | >180° C. |
| | ethanolamine | | | |
| 10 | Mono- | Maleimide | Water | >180° C. |
| | ethanolamine | | | |
| 11 | Triethylamine | Propenal | Water | >180° C. |
| 12 | Triethylamine | Maleimide | Water | 155° C. |
| 13 | Triethylamine | Methacrolein | Water | 170° C. |
| 14 | MEA triazine | Bromoacetic acid | Water | 150° C. |
| 15 | MEA triazine | Ethyl-2- | Water | 150° C. |
| | | chloroacetoacetate | | |
| 16 | MEA triazine | Diethyl | Water | 155° C. |
| | | bromomalonate | | |
| 17 | MEA triazine | Ethylbromoacetate | Water | 155° C. |
| 18 | MEA triazine | glyoxal | Water | 95° C. |

### EXAMPLE 2

The thermal stability of a variety of amines in combination with propenal was tested according to the procedure of Example 1. The results are provided in Table 2:

TABLE 2

| | | | Tempera- |
|---|---|---|---|
| | | | ture at |
| Ex- | | | which H₂S |
| am- | | | is re- |
| ple | Amine | Media | released |
| 19 | None | Water | Did not |
| | | | scavenge |
| | | | (sulfides |
| | | | remains) |
| 20 | 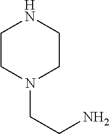 | Water | 180° C. |
| 21 | 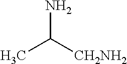 | Water | 180° C. |
| 22 | 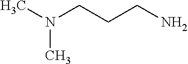 | Water | 180° C. |
| 23 | 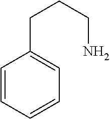 | Water | 180° C. |
| 24 | 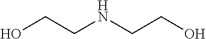 | Water | 180° C. |
| 25 | 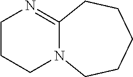 [SMILES: C1CCC2=NCCCN2CC1] | Water | >180° C. |
| 26 | 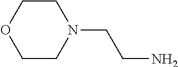 | Water | 180° C. |
| 27 | 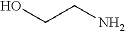 | Water | 180° C. |
| 28 | 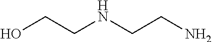 | Water | 180° C. |
| 29 | 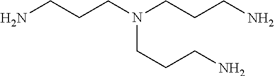 [SMILES: NCCCN(CCCN)CCCN] | Water | >180° C. |
| 30 | 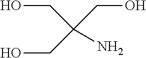 | Water | >180° C. |
| 31 | 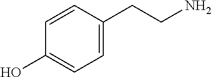 | Water | 180° C. |
| 32 | 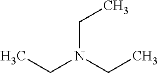 | Water | >180° C. |
| 33 | 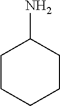 | Water | 180° C. |
| 34 | 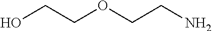 | Water | >180° C. |
| 35 | 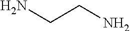 | Water | 180° C. |

### EXAMPLE 3

A combination of MEA triazine and propenal or MEA triazine and ethyl-2-chloroacetoacetate was incubated for 30 minutes at 75° C. in a variety of brines using a procedure analogous to that described in Example 1. The temperature at which hydrogen sulfide is re-released was measured.

The results are shown in Table 3.

TABLE 3

| | | | Temperature at |
|---|---|---|---|
| | Scavenger | Brine (% | which H₂S is re- |
| Example | Combination | dissolved salt) | released |
| 1B | MEA triazine | Deionised water | 100° C. |
| 2B | MEA triazine and | Deionised water | >180° C. |
| | Propenal | | |
| 3B | MEA triazine and | Bakken (25%) | >180° C. |
| | Propenal | | |
| 4B | MEA triazine and | IOC (11%) | >180° C. |
| | Propenal | | |
| 5B | MEA triazine and | Marcellus (8%) | >180° C. |
| | Propenal | | |
| 6B | MEA triazine and | Eagle Ford (2%) | >180° C. |
| | Propenal | | |
| 7B | MEA triazine and ethyl- | Deionised water | 150° C. |
| | 2-chloroacetoacetate | | |
| 8B | MEA triazine and ethyl- | Bakken (25%) | 150° C. |
| | 2-chloroacetoacetate | | |
| 9B | MEA triazine and ethyl- | IOC (11%) | 150° C. |
| | 2-chloroacetoacetate | | |
| 10B | MEA triazine and ethyl- | Marcellus (8%) | 150° C. |
| | 2-chloroacetoacetate | | |
| 11B | MEA triazine and ethyl- | Eagle Ford (2%) | 150° C. |
| | 2-chloroacetoacetate | | |

### EXAMPLE 4

The rate at which compounds and combinations of compounds scavenge hydrogen sulfide was measured as follows:

2 ml of a stock solution containing 0.6 mg/ml of Na₂S in water was added to water (18 ml) in a reaction vessel with stirrer bar. The vessel was tightly sealed and hydrogen sulfide was generated in situ by injecting HCl (0.07 ml of 0.5M solution, 2 molar equivalents relative to Na₂S). Thus the solution contained approximately 25 mg/I of hydrogen sulfide. The mixture was heated to 30° C. with stirring and an aliquot (0.3 ml) was removed via syringe and the liquid-phase H₂S content determined using a colourimetric test. This is the time=0 reading. 5 molar equivalents relative to Na₂S of an amino compound (a) and 5 molar equivalents relative to Na₂S of a compound including a soft electrophilic centre (b) were then injected and the scavenging monitored by testing aliquots of the mixture at set time intervals (typically 1, 5, 10 and 20 minutes).

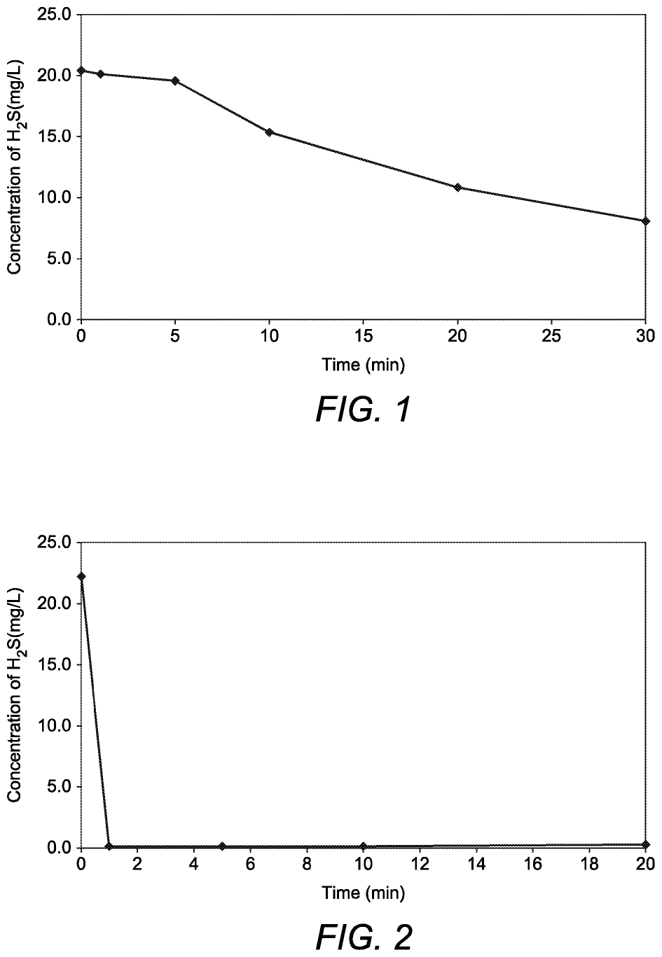

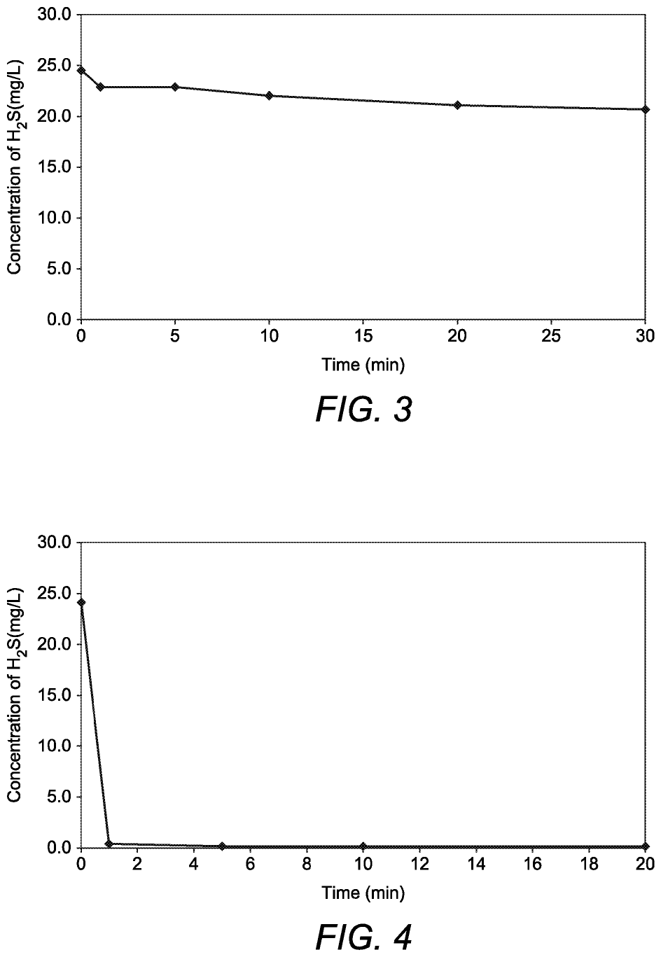

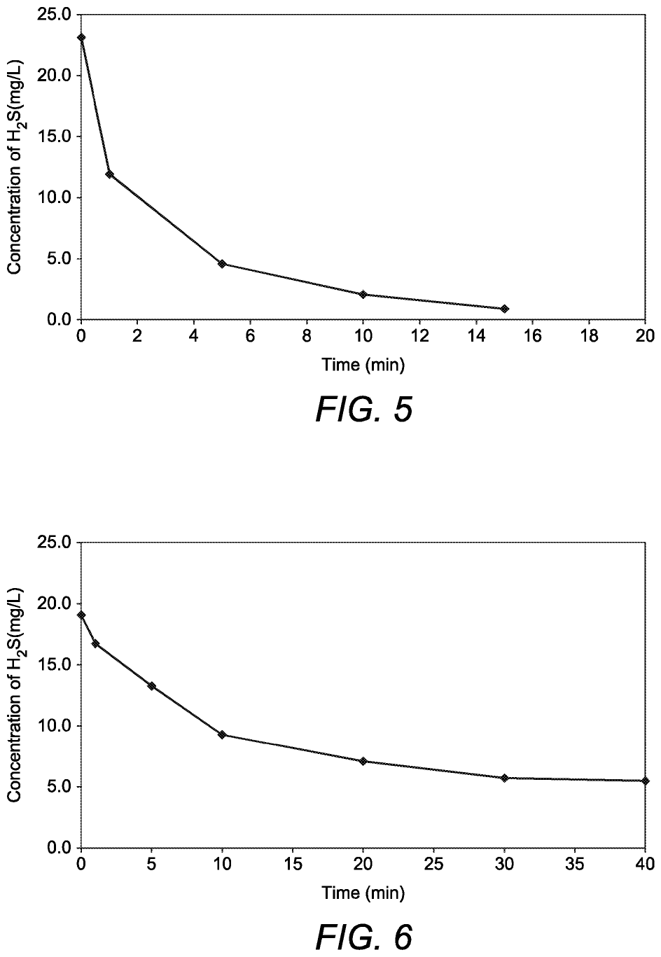

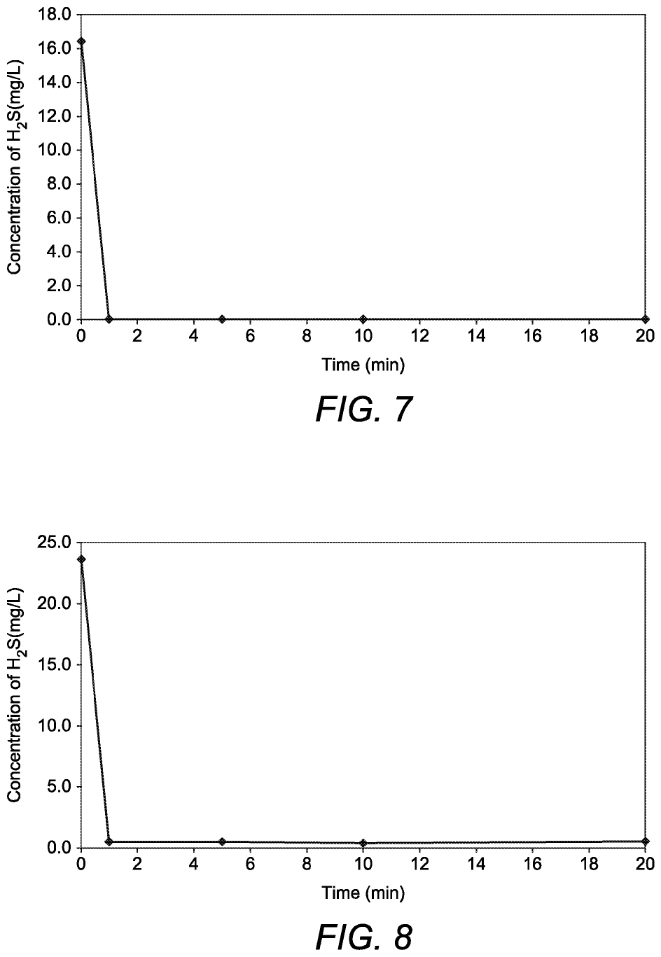

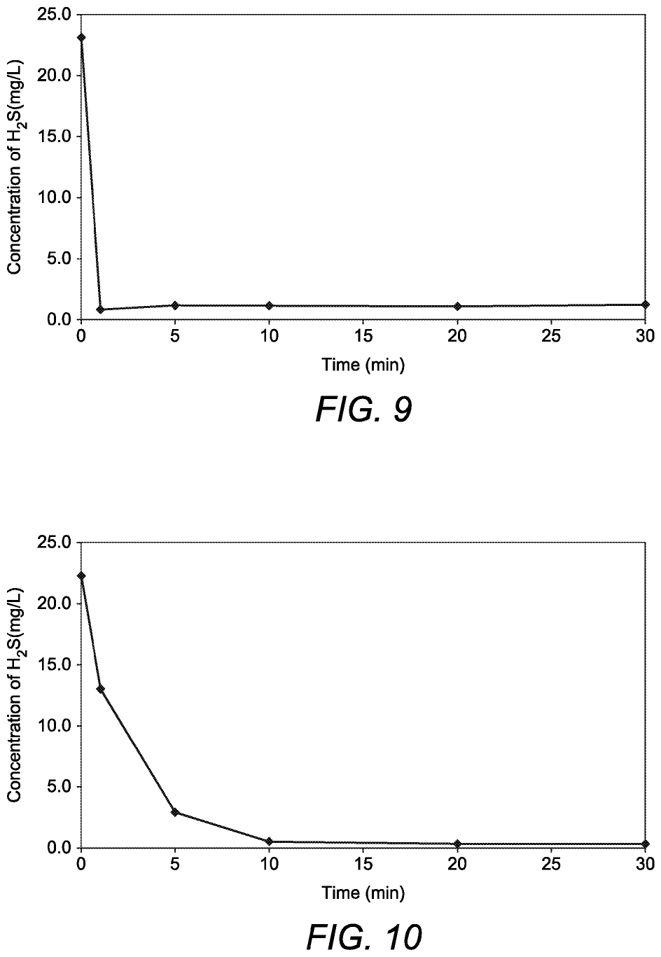

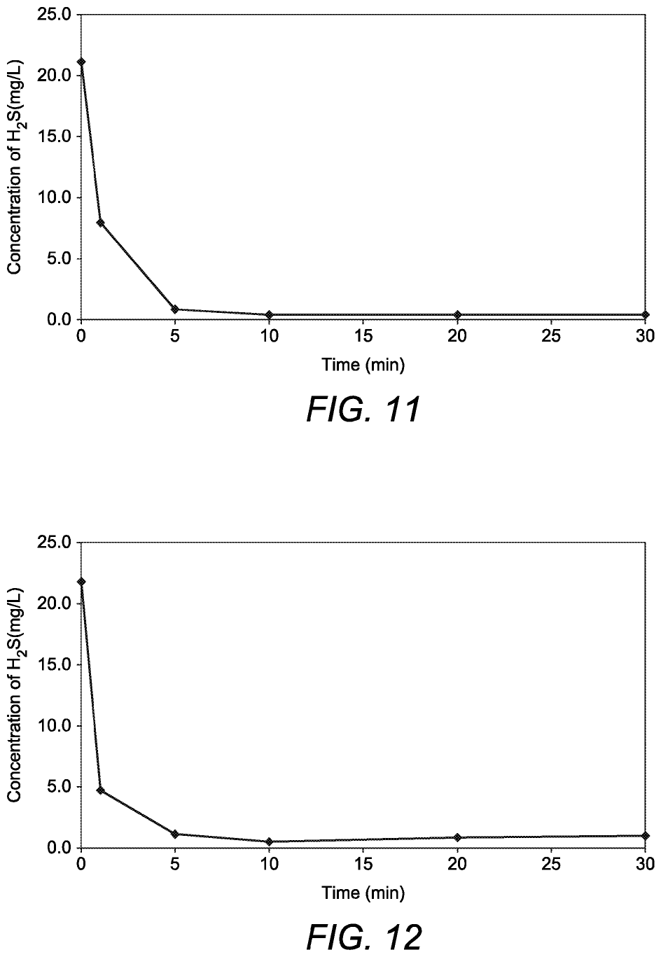

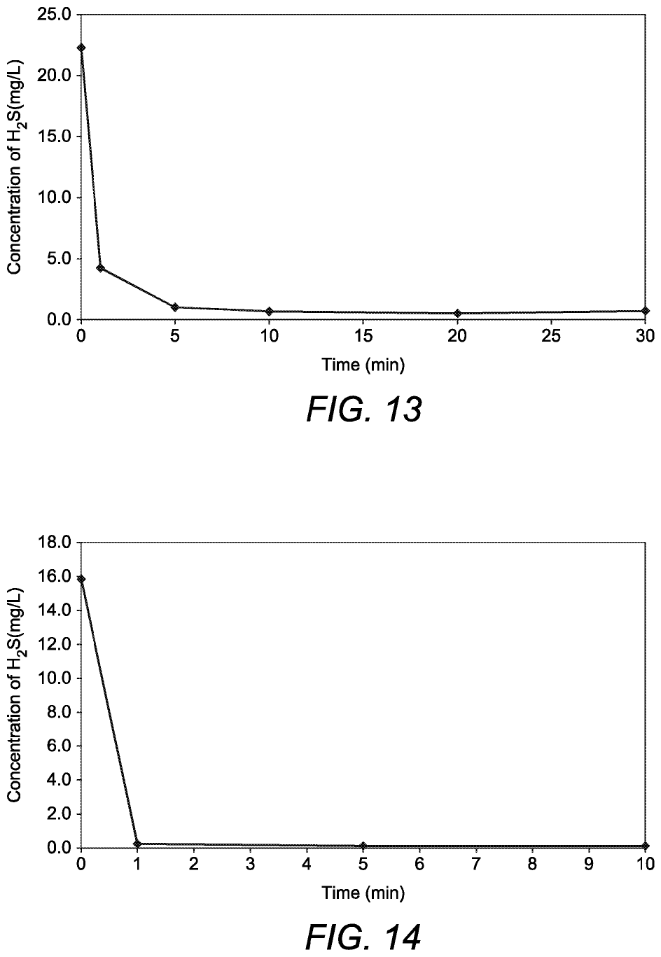

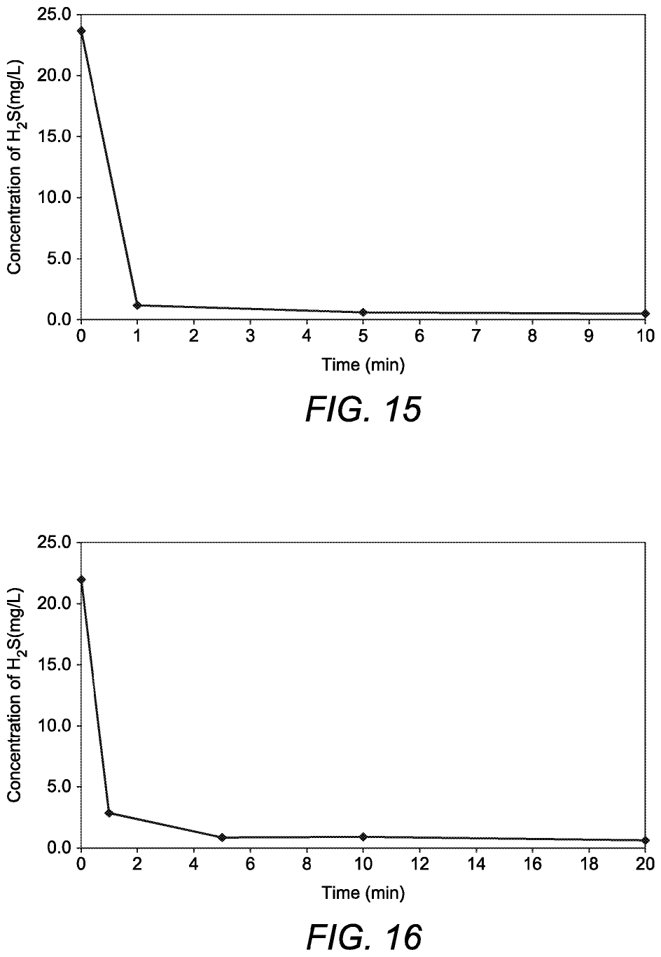

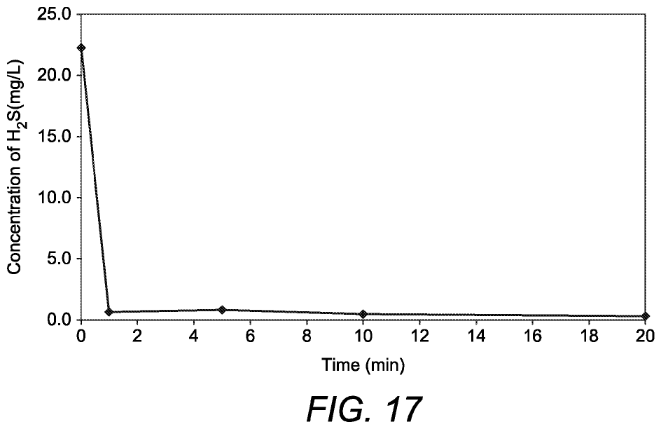

Table 4 and FIGS. 1 to 7 show how the using a combination of propenal or maleimide and a base increases the rate compared to the use of either component alone.

TABLE 4

| | Compound | | | | | | | | |
|---|---|---|---|---|---|---|---|---|---|
| | with soft | Average concentration of H₂S (mg/L) after period of: | | | | | | | |
| Amino | electrophilic | 0 | 1 | 5 | 10 | 15 | 20 | 30 | Figure |
| compound | centre (b) | min | min | min | min | min | min | min | number |
| MEA triazine | none | 20.6 | 20.3 | 19.7 | 15.5 | | 10.9 | 8.1 | 1 |
| MEA triazine | maleimide | 22.3 | 0.1 | 0.2 | 0.2 | | 0.2 | | 2 |
| None | propenal | 24.7 | 22.9 | 22.9 | 22.1 | | 21.2 | 20.9 | 3 |
| MEA triazine | propenal | 24.2 | 0.3 | 0.0 | 0.0 | | 0.0 | | 4 |
| ethanolamine | propenal | 23.1 | 11.9 | 4.5 | 2.0 | 0.9 | | | 5 |
| MBO | None | 19.1 | 16.8 | 13.3 | 9.3 | | 7.1 | 5.7 | 6 |
| MBO | Propenal | 16.4 | 0.0 | 0.0 | 0.0 | | 0.0 | | 7 |
| MEA triazine | Ethyl-2-chloro | 23.5 | 0.4 | 0.4 | 0.4 | | 0.6 | | 8 |
| | acetoacetate | | | | | | | | |
| MEA triazine | Maleic anhydride | 23.1 | 0.8 | 1.1 | 1.1 | | 1.1 | 1.3 | 9 |
| MEA triazine | Crotonaldehyde | 22.1 | 13.0 | 3.0 | 0.6 | | 0.4 | 0.3 | 10 |
| MEA triazine | Methacrolein | 21.2 | 8.0 | 0.8 | 0.3 | | 0.4 | 0.4 | 11 |
| MEA triazine | Bromoacetic acid | 21.8 | 4.8 | 1.2 | 0.5 | | 1.0 | 1.1 | 12 |
| MEA triazine | Chloroacetic acid | 22.3 | 4.3 | 1.0 | 0.8 | | 0.6 | 0.7 | 13 |
| MEA triazine | N-Methylol | 15.8 | 0.2 | 0.1 | 0.1 | | | | 14 |
| | maleimide | | | | | | | | |
| MEA triazine | 3-chloro-2,4- | 23.7 | 1.2 | 0.7 | 0.5 | | | | 15 |
| | pentanedione | | | | | | | | |
| MEA triazine | Maleic hydrazide | 22.2 | 2.9 | 0.8 | 0.9 | | 0.6 | | 16 |
| MEA triazine | 2,5-dioxo-2,5- | 22.1 | 0.7 | 0.8 | 0.5 | | 0.3 | | 17 |
| | dihydro-1H- | | | | | | | | |
| | pyrrole-1- | | | | | | | | |
| | carboxamide | | | | | | | | |

MBO is methylene bis(5-methyloxazolidine)

### EXAMPLE 5

A range of scavengers and scavenger combinations were contacted in excess amounts with an aqueous composition comprising hydrogen sulfide at different temperatures. The results are shown in table 5:

TABLE 5

| | Molar | H₂S | Solids remaining after | | |
|---|---|---|---|---|---|
| | ratio (to 1 | detected | scavenging: | | |
| Scavenger | eq H₂S | at end? | at 30° C.? | at 80° C.? | at 180° C.? |
| MEA | 5 | yes | no | no | no |
| triazine | | | | | |
| MEA | 2 | yes | no | no | yes |
| triazine | | | | | |
| A | 5 | no | no | no | no |
| A | 2 | no | no | no | no |
| B | 5 | no | no | no | no |
| B | 2 | no | no | no | no |
| C | 5 | no | no | no | no |
| C | 2 | no | no | no | no |

Scavenger A contained 1 part MEA triazine and 2 parts maleimide.
Scavenger B contained 1 part MEA triazine and 4 parts maleimide.
Scavenger C contained 1 part MEA triazine and 2.7 parts ethyl-2-chloroacetoacetate.

1-3. (canceled)

4. A method of scavenging an acidic sulfide species from an industrial or environmental material, the method comprising contacting the material with:
(a) an amino compound selected from triazines, oxazolidines, polyamines and amines of formula R¹R²R³N in which each of R¹, R² and R³ is independently hydrogen or an alkyl group which is optionally substituted with a group selected from hydroxy, alkoxy, amino, alkylamino, dialkylamino or aryl, provided that at least one of R¹, R² and R³ is not hydrogen; and
(b) a compound including a soft electrophilic centre.

5. The method according to claim 4 wherein the amino compound and the compound including a soft electrophilic centre are provided in a single composition or in separate compositions.

6. The method according to claim 5 wherein the amino compound and the compound including a soft electrophilic centre are provided in separate compositions.

7. The method according to claim 6 wherein the industrial or environmental material is contacted concurrently with a composition comprising an amino compound and a composition comprising a compound including an electrophilic centre.

8. The method according to claim 4 wherein the industrial or environmental material is selected from crude oil, produced water, petroleum refinery liquids, coke, asphalt or bitumen, used fracturing fluids, used water-flooding fluids, brines, geothermal fluids or sour gas.

9. The method according to claim 4 in which an acidic sulfide species is scavenged and retained from an industrial or environmental material comprising water.

10. The method according to claim 4 in which the acidic sulfide species is hydrogen sulfide.

11. A product for scavenging acid sulfide species, the product comprising:
(a) an amino compound selected from triazines, oxazolidines, polyamines and amines of formula R¹R²R³N in which each of R¹, R² and R³ is independently hydrogen or an alkyl group which is optionally substituted with a group selected from hydroxy, alkoxy, amino, alkylamino, dialkylamino or aryl, provided that at least one of R¹, R² and R³ is not hydrogen; and
(b) a composition comprising a compound including a soft electrophilic centre.

12. The product according to claim 11 wherein the amino compound is provided in an aqueous or organic composition.

13. The product according to claim 11 wherein the compound including the soft electrophilic centre is provided in an aqueous or organic composition.

14. The product according to claim 11 wherein the amino compound is selected from monoethanolamine triazine (MEA triazine), monomethylamine triazine (MMA triazine), methoxypropylamine triazine (MOPA triazine), methylene bis(5-methyloxazolidine), monoethanolamine, triethylamine, methoxypropylamine, cyclohexylamine, triethanolamine, 3-phenylpropylamine, diethanolamine, 2-aminopropylamine, tributylamine, N-(2-hydroxyethyl)ethylenediamine, N¹,N¹-bis(2-aminoethyl)-1,2-ethanediamine, 1-(2-aminoethyl)piperazine, 4-(2-aminoethyl)phenol, 2-amino-2-(hydroxymethyl)propane-1,3-diol, 4-(2-aminoethyl)morpholine, 2-(2-aminoethoxy)ethanol, dimethylaminopropylamine, ethylene diamine and 1,8-diazabicyclo(5.4.0)undec-7-ene (DBU).

15. The product according to claim 11 wherein the amino compound is selected from monomethylamino triazine, monoethanolamine triazine and methoxypropylamine triazine.

16. The product according to claim 11 wherein the compound including an electrophilic centre is selected from compounds including a halogen substituent adjacent to a carbonyl group, compounds including a bromide functional group and compounds including an α,β-unsaturated carbonyl group or a reactive equivalent thereof.

17. The product according to claim 11 wherein the compound including an electrophilic centre is selected from compounds including a bromide functional group and compounds including an α,β-unsaturated carbonyl group or a reactive equivalent thereof.

18. The product according to claim 11 wherein the compound including an electrophilic centre is selected from α,β-unsaturated aldehydes, optionally substituted maleimides, maleic anhydride and halogenated compounds including an electron deficient carbon atom.

19. The product according to claim 11 wherein the compound including a soft electrophilic centre is an α,β-unsaturated aldehyde or a maleimide.

20. The product according to claim 11 wherein the compound including a soft electrophilic centre is selected from propenal, maleimide, maleic anhydride, ethyl-2-chloroacetoacetate and mixtures thereof.

21. The product according to claim 11 wherein the compound including an electrophilic centre is propenal.

22. The product according to claim 11 which scavenges and retains hydrogen sulfide at temperatures in excess of 140° C.

23. The product according to claim 11 which further comprises (c) a scale inhibitor and/or a corrosion inhibitor.

24. The product according to claim 11 which further comprises one or more further components selected from biocides, friction reducers, drag reducing agents, surfactants, foaming agents, carbon dioxide scavengers, oxygen scavengers and metal scavengers

25. The product according to claim 11 which further comprises means for delivering the composition comprising the amino compound and/or the composition comprising the compound including a soft electrophilic centre to the industrial or environmental material.

26. (canceled)

27. The method according to claim 4 wherein the amino compound is provided in an aqueous or organic composition.

28. The method according to claim 4 wherein the compound including the soft electrophilic centre is provided in an aqueous or organic composition.

29. The method according to claim 4 wherein the amino compound is selected from monoethanolamine triazine (MEA triazine), monomethylamine triazine (MMA triazine), methoxypropylamine triazine (MOPA triazine), methylene bis(5-methyloxazolidine), monoethanolamine, triethylamine, methoxypropylamine, cyclohexylamine, triethanolamine, 3-phenylpropylamine, diethanolamine, 2-aminopropylamine, tributylamine, N-(2-hydroxyethyl)ethylenediamine, N¹,N¹-bis(2-aminoethyl)-1,2-ethanediamine, 1-(2-aminoethyl)piperazine, 4-(2-aminoethyl)phenol, 2-amino-2-(hydroxymethyl)propane-1,3-diol, 4-(2-aminoethyl)morpholine, 2-(2-aminoethoxy)ethanol, dimethylaminopropylamine, ethylene diamine and 1,8-diazabicyclo(5.4.0)undec-7-ene (DBU).

30. The method according to claim 4 wherein the amino compound is selected from monomethylamino triazine, monoethanolamine triazine and methoxypropylamine triazine.

31. The method according to claim 4 wherein the compound including an electrophilic centre is selected from compounds including a halogen substituent adjacent to a carbonyl group, compounds including a bromide functional group and compounds including an α,β-unsaturated carbonyl group or a reactive equivalent thereof.

32. The method according to claim 4 wherein the compound including an electrophilic centre is selected from compounds including a bromide functional group and compounds including an α,β-unsaturated carbonyl group or a reactive equivalent thereof.

33. The method according to claim 4 wherein the compound including an electrophilic centre is selected from α,β-unsaturated aldehydes, optionally substituted maleimides, maleic anhydride and halogenated compounds including an electron deficient carbon atom.

34. The method according to claim 4 wherein the compound including a soft electrophilic centre is an α,β-unsaturated aldehyde or a maleimide.

35. The method according to claim 4 wherein the compound including a soft electrophilic centre is selected from propenal, maleimide, maleic anhydride, ethyl-2-chloroacetoacetate and mixtures thereof.

36. The method according to claim 4 wherein the compound including an electrophilic centre is propenal.

37. The method according to claim 4 which scavenges and retains hydrogen sulfide at temperatures in excess of 140° C.
